(19) United States
(12) Patent Application Publication
(10) Pub. No.: US 2026/0234405 A1
(43) Pub. Date: Aug. 13, 2026

(54) BIODEGRADABLE DYE COMPOSITIONS AND APPLICATIONS THEREOF

(71) Applicant: Spectronics Corporation, Melville, NY (US)

(72) Inventors: Annmarie Karmakar, Bay Shore, NY (US); Michael Fleming, Bayport, NY (US); Tom Oliveri, Dix Hills, NY (US)

(21) Appl. No.: 19/052,506

(22) Filed: Feb. 13, 2025

(51) Int. Cl. C09B 57/08; G01N 21/64

(52) U.S. Cl. CPC C09B 57/08; G01N 21/6428; G01N 2021/6439

(57) ABSTRACT

Readily biodegradable dye compositions for detecting sites of fluid leakage comprising a fluorescent component and an oil base are provided. Methods for detecting sites of fluid leakage using the biodegradable dye composition are disclosed.

### FIELD

The present disclosure relates to biodegradable dye compositions for detecting sites of fluid leakage, in particular, to oil-based and readily biodegradable fluorescent dye compositions and applications or uses for these compositions.

### BACKGROUND

Operating hydraulic equipment in environmentally sensitive areas requires strict adherence to environmental regulations, such as relying on expensive, readily biodegradable oils as a fuel source. Moreover, hydraulic equipment may be prone to leakage, resulting in the loss of these expensive, readily biodegradable oils. Therefore, it is important to regularly assess hydraulic equipment for leaks. To comply with environmental regulations, any leak detection system that is used in environmentally sensitive areas must also be readily biodegradable to avoid contaminating the environment.

Traditional methods for leak detection include fluorescent-based systems, wherein a composition comprising a fluorescent dye is added to a system and an ultraviolet (UV) light is used to detect any leaks throughout the system. However, most of the biodegradable dye compositions that are currently used for leak detection are water-soluble, making them incompatible with oil-based systems. As a result, there remains an unmet need for readily biodegradable dye compositions that (i) are compatible with oil-based systems and (ii) do not compromise the biodegradability of the overall fluid system in the equipment.

### SUMMARY

The present disclosure provides readily biodegradable oil-based fluorescent dye compositions, and applications or uses for these dye compositions.

In one form thereof, the present disclosure provides a biodegradable dye composition comprising a fluorescent component and an oil base.

In another form thereof, the present disclosure provides a method for detecting leaks in oil-based systems comprising introducing the biodegradable dye composition into the oil-based system and detecting the leak.

Further and alternative aspects and features of the disclosed invention will be apparent from the following detailed description. As will be appreciated, the methods disclosed herein are capable of being carried out and used in other and different aspects, and capable of being modified in various respects. Accordingly, it is to be understood that both the foregoing general description and the following detailed description are only exemplary and explanatory and do not restrict in any way the scope of the claimed invention.

### BRIEF DESCRIPTION OF THE DRAWINGS

FIG. 1 shows a plot of biodegradation versus time for the test sample and the reference sample of Example 1.

FIG. 2 shows a plot of the emission spectrum of the test sample of Example 1 as a 0.05% dilution in ethanol.

FIG. 3 shows a plot of the UV-VIS spectrum of the test sample of Example 1 as a 0.05% dilution in ethanol.

### DETAILED DESCRIPTION

The present disclosure relates to biodegradable dye compositions for detecting sites of fluid leakage, in particular, to oil-based and readily biodegradable fluorescent dye compositions and applications or uses for these compositions.

The biodegradable dye compositions of the present disclosure meet or exceed the standards for readily biodegradable materials as defined by OECD 301B. The OECD 301B test, otherwise known as the “Modified Sturm Test,” was adopted by the Organization for Economic Cooperation Development in 1992 and helps assess the potential environmental impact of chemicals by evaluating their ability to be broken down by microorganisms in aerobic aqueous systems. In particular, the test measures the carbon dioxide evolution from the microbial degradation of an organic compound under aerobic conditions.

The present disclosure provides biodegradable dye compositions for detecting sites of fluid leakage, the compositions comprise a fluorescent component and an oil base. In certain aspects, the biodegradable dye compositions are compatible with oil-based systems and do not compromise the biodegradability of the overall fluid system in the equipment, system, or machinery being used.

The fluorescent component of the biodegradable dye composition comprises a fluorescing dye. The fluorescing dye may emit blue light, green light, yellow light, orange light, red light, or a combination thereof. In certain aspects, the fluorescing dye emits green light. In other aspects, the fluorescing dye may emit light at a wavelength in the range of from about 380 nm to about 750 nm, e.g., about 380 nm, about 385 nm, about 390 nm, about 395 nm, about 400 nm, about 405 nm, about 410 nm, about 415 nm, about 420 nm, about 425 nm, about 430 nm, about 435 nm, about 440 nm, about 445 nm, about 450 nm, about 455 nm, about 460 nm, about 465 nm, about 470 nm, about 475 nm, about 480 nm, about 485 nm, about 490 nm, about 495 nm, about 500 nm, about 505 nm, about 510 nm, about 515 nm, about 520 nm, about 525 nm, about 530 nm, about 535 nm, about 540 nm, about 545 nm, about 550 nm, about 555 nm, about 560 nm, about 565 nm, about 570 nm, about 575 nm, about 580 nm, about 585 nm, about 590 nm, about 595 nm, about 600 nm, about 605 nm, about 610 nm, about 615 nm, about 620 nm, about 625 nm, about 630 nm, about 635 nm, about 640 nm, about 645 nm, about 650 nm, about 655 nm, about 660 nm, about 665 nm, about 670 nm, about 675 nm, about 680 nm, about 685 nm, about 690 nm, about 695 nm, about 700 nm, about 705 nm, about 710 nm, about 715 nm, about 720 nm, about 725 nm, about 730 nm, about 735 nm, about 740 nm, about 745 nm, or about 750 nm.

In some aspects, the fluorescing dye is a napthalimide dye, a perylene dye, a pyrene dye, an anthracene dye, a coumarin dye, or a combination thereof. In certain aspects, the fluorescing dye is a napthalimide dye or a napthalimide diester dye. In other aspects, the fluorescing dye is a benzo[de]isoquinoline-1,3-dione compound, a perylene-based compound, a naphthalimide-based compound, or a combination of perylene and napthalimide-based compounds. Exemplary dyes are disclosed, for example, in U.S. Pat. No. 6,248,890. The contents of U.S. Pat. No. 6,248,890 are incorporated herein in their entirety, in particular the description of a fluorescent naphthalimide dye from col. 1, line 66 to col. 2, line 39.

In certain aspects, the fluorescing dye has a structure of Formula (I):

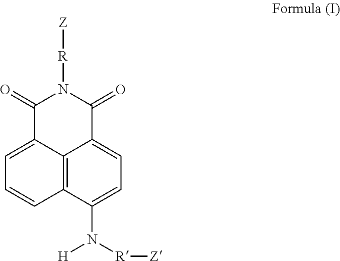

wherein
Z and Z′ are each independently esters having a saturated or unsaturated, linear or branched, hydrocarbon chain attached thereto, having from 8 to 24 carbon atoms in length, and from 1 to 4 double bonds;
R and R′ are each independently saturated, linear hydrocarbon chains, having from 2 to 10 carbon atoms in length, wherein R is attached to Z by the ester linkage, and wherein R′ is attached to Z′ by the ester linkage; and
Z and Z′ are each independently esters of fatty acids. Exemplary linear fatty acid esters are, for example esters of: decanoic acid, nonanoic acid, octanoic acid, citronellic acid, undecanoic acid, lauric acid, tridecanoic acid, myristoleic acid, myristic acid, pentadecanoic acid, palmitoleic acid, palmitic acid, heptadecanoic acid, linolenic acid, linoleic acid, oleic acid, nonadecanoic acid, cis-11-eicosanoic acid, eicosanoic acid, 11, 14-eicosadienoic acid, erucic acid, docosanoic acid, and behenic acid. Preferred branched acids are, for example: isononanoic acid, neoheptanoic acid, neononanoic acid, neodecanoic acid, iso-octanoic acid, neo octanoic acid, and isostearic acid.

The oil base of the biodegradable dye composition comprises a biodegradable oil that is compatible with hydrocarbon-based systems. In some aspects, the biodegradable oil is a polyol ester, a polyalkylene glycol, vegetable oil, a triglyceride ester, a synthetic ester, hydrotreated vegetable oil, a polyalphaolefin, canola oil, soybean oil, sunflower oil, castor oil, a pentaerythitol ester, a neopolyol ester, a diester, or a combination thereof. In certain aspects, the biodegradable oil is a polyol ester.

Exemplary biodegradable oils are disclosed, for example, in U.S. Pat. No. 7,517,837. The contents of U.S. Pat. No. 7,517,837 are incorporated herein in their entirety, in particular the description of the synthetic ester base oil from col. 3, line 23 to col. 5, line 10. In some aspects, the biodegradable oil comprises a biodegradable base oil, an overbased calcium sulfonate, a thickener system, a phosphatide anti-wear agent, and a solid film lubricant. In certain aspects, the biodegradable base oil is prepared by reacting at least one neopentyl glycol of Formula (II):

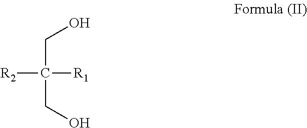

with a monocarboxylic acid mixture comprising at least one normal alkanoic acid having 5 to 18 carbon atoms, wherein R₁ and R₂ are each independently selected from the group consisting of CH₃, C₂H₅, add CH₂OH.

The biodegradable dye compositions of the present disclosure comprise a fluorescent component and an oil base, wherein the volume of the fluorescent component and the volume of the oil base sum to 100% (v/v).

For example, the fluorescent component comprises about 2% to about 70% (v/v %) of the total composition, e.g., about 2%, about 5%, about 10%, about 15%, about 20%, about 25%, about 30%, about 35%, about 40%, about 45%, about 50%, about 55%, about 60%, about 65%, or about 70%. In some aspects, the fluorescent component comprises about 10% to about 50% (v/v %) of the total composition, e.g., about 10%, about 15%, about 20%, about 25%, about 30%, about 35%, about 40%, about 45%, or about 50%. In certain aspects, the fluorescent component comprises about 15% to about 20% (v/v %) of the total composition, e.g., about 15%, about 15.5%, about 16%, about 16.5%, about 17%, about 17.5%, about 18%, about 18.5%, about 19%, about 19.5%, or about 20%.

The oil base of the biodegradable dye composition of the present disclosure comprises about 30% to about 98% (v/v %) of the total composition, e.g., about 30%, about 35%, about 40%, about 45%, about 50%, about 55%, about 60%, about 65%, about 70%, about 75%, about 80%, about 85%, about 90%, about 95%, or about 98%. In other aspects, the oil base comprises about 50% to about 90% (v/v %) of the total composition, e.g., about 50%, about 55%, about 60%, about 65%, about 70%, about 75%, about 80%, about 85%, or about 90%. In another aspect, the oil base comprises about 80% to about 85% (v/v %) of the total composition, e.g., about 80%, about 80.5%, about 81%, about 81.5%, about 82%, about 82.5%, about 83%, about 83.5%, about 84%, about 84.5%, or about 85%.

The biodegradable dye compositions of the present disclosure are completely miscible with biodegradable hydraulic fluids, petroleum fuels, lubricating oils, hydraulic oils, and hydrocarbon solvents, such that the biodegradable dye compositions can be used in systems that operate using biodegradable hydraulic fluids, petroleum fuels, lubricating oils, hydraulic oils, and hydrocarbon solvents. For example, the biodegradable dye compositions are compatible with marine equipment and vessels, equipment for water treatment systems, agricultural equipment, forestry equipment, mining equipment, construction equipment, aerospace systems and equipment, automotive systems and equipment, energy and utility equipment, industrial hydraulic systems, industrial machinery, hydraulic excavators, drilling equipment, industrial HVAC systems, air conditioning systems, refrigeration systems, and generators.

The biodegradable dye compositions of the present disclosure can be used to detect leaks in equipment, systems, or machinery. In certain aspects, the biodegradable dye compositions can be used to detect leaks in equipment, systems, or machinery that is used or operated in environmentally sensitive areas. For example, the environmentally sensitive areas may include oceans, forests, mangrove forests, farmlands, wetlands, floodplains, coastal dunes, coral reefs, rivers, stream, marshes, estuaries, prairies, grasslands, deserts, critical wildlife habitats, wildlife sanctuaries, endangered species breeding grounds or nesting sites, freshwater springs, watersheds, aquifers, and national parks.

The present disclosure provides a method of detecting leaks in oil-based systems, comprising (i) introducing the biodegradable dye composition into the oil-based system and (ii) detecting the leak.

In some aspects, the leak may be detected with a UV lamp. In other aspects, the leak may be detected with a non-UV lamp that emits light having a wavelength selected to cause the biodegradable dye composition to fluoresce. In certain aspects, the leak may be detected with a lamp that emits light at a wavelength in the range of from about 360 nm to about 495 nm, e.g., about 360 nm, about 365 nm, about 370 nm, about 375 nm, about 380 nm, about 385 nm, about 390 nm, about 395 nm, about 400 nm, about 405 nm, about 410 nm, about 415 nm, about 420 nm, about 425 nm, about 430 nm, about 435 nm, about 440 nm, about 445 nm, about 450 nm, about 455 nm, about 460 nm, about 465 nm, about 470 nm, about 475 nm, about 480 nm, about 485 nm, about 490 nm, or about 495 nm.

The method of the present disclosure comprises introducing a biodegradable dye composition into the oil-based system, wherein the oil base of the biodegradable dye compositions is a biodegradable oil that is compatible with hydrocarbon-based systems. In certain aspects, the biodegradable oil is a polyol ester, a polyalkylene glycol, vegetable oil, a triglyceride ester, a synthetic ester, hydrotreated vegetable oil, a polyalphaolefin, canola oil, soybean oil, sunflower oil, castor oil, a pentaerythitol ester, a neopolyol ester, a diester, or a combination thereof. In other aspects, the biodegradable oil is a polyol ester.

The method of the present disclosure comprises introducing a biodegradable dye composition into the oil-based system, wherein the fluorescent component of the biodegradable dye composition comprises a fluorescing dye concentrate. In certain aspects, the fluorescing dye concentrate comprises a napthalimide dye, a perylene dye, a pyrene dye, an anthracene dye, a coumarin dye, or a combination thereof. In some aspects, the fluorescing dye concentrate is a napthalimide dye.

The method of the present disclosure comprises introducing a biodegradable dye composition into the oil-based system, wherein the volume of the fluorescent component and the volume of the oil base must sum to 100% (v/v).

For example, the fluorescent component comprises about 2% to about 70% (v/v %) of the total composition, e.g., about 2%, about 5%, about 10%, about 15%, about 20%, about 25%, about 30%, about 35%, about 40%, about 45%, about 50%, about 55%, about 60%, about 65%, or about 70%. In some aspects, the fluorescent component comprises about 10% to about 50% (v/v %) of the total composition, e.g., about 10%, about 15%, about 20%, about 25%, about 30%, about 35%, about 40%, about 45%, or about 50%. In certain aspects, the fluorescent component comprises about 15% to about 20% (v/v %) of the total composition, e.g., about 15%, about 15.5%, about 16%, about 16.5%, about 17%, about 17.5%, about 18%, about 18.5%, about 19%, about 19.5%, or about 20%.

The oil base of the biodegradable dye composition of the present disclosure comprises about 30% to about 98% (v/v %) of the total composition, e.g., about 30%, about 35%, about 40%, about 45%, about 50%, about 55%, about 60%, about 65%, about 70%, about 75%, about 80%, about 85%, about 90%, about 95%, or about 98%. In other aspects, the oil base comprises about 50% to about 90% (v/v %) of the total composition, e.g., about 50%, about 55%, about 60%, about 65%, about 70%, about 75%, about 80%, about 85%, or about 90%. In another aspect, the oil base comprises about 80% to about 85% (v/v %) of the total composition, e.g., about 80%, about 80.5%, about 81%, about 81.5%, about 82%, about 82.5%, about 83%, about 83.5%, about 84%, about 84.5%, or about 85%.

As used herein, the term “equipment” refers to any vessels, vehicles, machinery, or instrumentation that may be used in the particular landscape or region being referenced. For example, “agricultural equipment” refers to any vessels, vehicles, machinery, or instrumentation that may be utilized in an agricultural setting that may require leak detection analysis.

As used herein, the phrase “environmentally sensitive areas” refers to areas that have unique environmental features, resources, or ecosystems that are particularly vulnerable to disturbances or degradation by human activities.

As used herein, the term “biodegradable,” with respect to the dye composition means that the composition can be broken down naturally within a reasonable timeframe without human intervention and the byproducts of such degradation are not harmful, toxic, or negatively impact the surrounding environment or ecosystem.

As used herein, the phrase “readily biodegradable,” with respect to the dye composition means that the dye composition meets or exceeds the standards for readily biodegradable materials as defined by OECD 301B.

As used herein, the term “fluorescent,” with respect to the dye composition means that the dye composition includes a component that can absorb light at a specific wavelength (i.e., ultraviolet light) and emit light at a different wavelength (i.e., visible light).

As used herein, the phrase “hydrocarbon-based system” refers to any system that relies on hydrocarbons or compounds composed solely of carbon and hydrogen atoms as its energy source.

As used herein, the term “about”, when used in connection with recited weight percentages of the components of the present compositions, includes a deviation of ±0.3% from the recited weight percentage.

As used herein, the singular forms “a”, “an” and “the” include plural unless the context clearly dictates otherwise. Moreover, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the disclosure be limited to the specific values recited when defining a range.

### EXAMPLES

### Example 1: Preparation of the Biodegradable Dye Composition

In this study, a biodegradable dye composition was prepared by mixing the fluorescent dye component and the biodegradable oil component until the mixture was homogenous. The resulting homogenous mixture was subjected to a series of characterization tests, the results of which are shown in Tables 1-3.

TABLE 1
Metal Content of the Biodegradable Dye Composition

| Wear | | Contaminant | | Multi-Source | | Additive | |
|---|---|---|---|---|---|---|---|
| Metals (ppm) | | Metals (ppm) | | Metals (ppm) | | Metals (ppm) | |
| Iron | 1 | Silicon | 4 | Titanium | 0 | Magnesium | 1 |
| Chromium | 0 | | | | | | |
| Nickel | 0 | | | Molybdenum | 0 | Calcium | 2 |
| Aluminum | 0 | Sodium | 2 | | | | |
| Copper | 0 | | | Antimony | 0 | Barium | 0 |
| Lead | 0 | | | | | | |
| Tin | 51 | Potassium | 5 | Manganese | 0 | Phosphorous | 10 |
| Cadmium | 0 | | | | | | |
| Silver | 0 | | | Lithium | 1 | Zinc | 1 |
| Vanadium | 0 | | | Boron | 0 | | |

TABLE 2
Contaminants and Fluid Properties of
the Biodegradable Dye Composition

| | |
|---|---|
| Contaminants (%) | Fluid Properties |

| | | | |
|---|---|---|---|
| Fuel Dilution | — | Viscosity 40° C. | 34.6 |
| | | (cSt) | |
| | | Viscosity 100° C. | 6.5 |
| | | (cSt) | |
| Soot | — | Acid Number (mg | 2.04 |
| | | KOH/g) | |
| | | Base Number | — |
| | | D4729 (mg KOH/g) | |
| Water | <.1 (FTIR) | Oxidation (abs/cm) | 163 |
| | | Nitration (abs/0.1 | 23 |
| | | mm) | |

TABLE 3
Particle Count and Additional Testing
of the Biodegradable Dye Composition

| Particle Count (Test Method = ASTM | | | |
|---|---|---|---|
| D7647) | | Additional testing | |
| >4 (particles/mL) | 6219 | Density (g/mL) | 0.9602 |
| >6 (particles/mL) | 1761 | | |
| >10 (particles/mL) | 321 | | |
| >14 (particles/mL) | 92 | | |
| >21 (particles/mL) | 19 | Closed Cup Flash | 214.0 |
| >38 (particles/mL) | 1 | Point (° C.) | |
| >70 (particles/mL) | 0 | | |
| >100 (particles/mL) | 0 | | |

### Example 2: Effects of the Biodegradable Dye Composition on the Host Oil

In this study, the effects of the biodegradable dye composition on the host oil were examined. In particular, the biodegradable dye composition of Example 1 was prepared, and then a 1:1000 dilution of the dye composition in a host oil was prepared. Characterization studies such as metal content, viscosity, acid number, base number, particle count, flash point, water content, and specific gravity were determined for the dye composition, the host oil, and the 1:1000 dilution of the dye in the host oil. The results of this study are shown in Table 4.

TABLE 4
Host Oil Characterization Studies

| | | |
|---|---|---|
| 1:1000 DILUTION | | DYE |
| (DYE IN HOST OIL) | HOST OIL | COMPOSITION |

Wear Metals (ppm)

| | | | |
|---|---|---|---|
| Iron | 0 | 0 | 0 |
| Chromium | 0 | 0 | 0 |
| Lead | 0 | 0 | 0 |
| Copper | 0 | 0 | 0 |
| Tin | 2 | 2 | 60 |
| Aluminum | 0 | 0 | 0 |
| Nickel | 0 | 0 | 0 |
| Silver | 0 | 0 | 0 |
| Silicon | 0 | 0 | 7 |
| Potassium | 0 | 0 | 6 |
| Sodium | 0 | 0 | 2 |
| Boron | 0 | 0 | 0 |
| Magnesium | 0 | 0 | 1 |
| Calcium | 0 | 1 | 2 |
| Barium | 0 | 0 | 0 |
| Phosphorus | 178 | 192 | 0 |
| Zinc | 0 | 1 | 0 |
| Molybdenum | 1 | 0 | 1 |
| Titanium | 0 | 0 | 1 |
| Vanadium | 0 | 1 | 1 |

Viscosity 40° C. (cSt)

| | | |
|---|---|---|
| 46.2 | 46 | 34.8 |

Viscosity 100° C. (cSt)

| | | |
|---|---|---|
| 9.3 | 9.4 | 6.6 |

TAN (mg KOH/g)

| | | |
|---|---|---|
| 0.97 | 1 | 1.68 |

TBN (mg KOH/g)

| | | |
|---|---|---|
| 0.1 | 0.1 | 0.1 |

ISO Code

| | | |
|---|---|---|
| 19/14/1 | 18/16/10 | 20/18/14 |

Particle Count (particles/ mL)

| | | | |
|---|---|---|---|
| 4 | 3402 | 2398 | 6238 |
| 6 | 128 | 502 | 1354 |
| 14 | 0 | 5 | 88 |
| 21 | 0 | 2 | 8 |
| 38 | 0 | 0 | 0 |
| 70 | 0 | 0 | 0 |

Flash Point (° C.)

| | | |
|---|---|---|
| >200 | >200 | >200 |

Water Content (ppm)

| | | |
|---|---|---|
| 286 | 325 | 378 |

Specific Gravity

| | | |
|---|---|---|
| 0.912 | 0.912 | 0.894 |

The results of this study indicated that the biodegradable dye composition had no significant impact on the physical properties of the host oil.

### Example 3: Biodegradation Studies

In this study, the biodegradability of the dye composition of Example 1 was measured according to OECD 301B.

In particular, a medium containing a known concentration of the dye composition (e.g., 10-20 mg) and a medium containing an inoculum blank were aerated by the passage of carbon dioxide-free air at a controlled rate (e.g., 30-100 ml/min) in the dark or in diffuse light. Degradation of both samples was followed over 28 days by determining the amount of carbon dioxide that was produced. The carbon dioxide that was generated was trapped in barium or sodium hydroxide and was measured by titration of the residual hydroxide or as inorganic carbon. The amount of carbon dioxide produced from the dye composition, which was corrected for that derived from the blank inoculum, was expressed as a percentage of theoretical carbon dioxide. The results of the degradation study are shown in Table 5.

TABLE 5
Biodegradability Results

| | Reference | Biodegradable Dye Composition | | | |
|---|---|---|---|---|---|
| Time (day) | Mean | Rep #1 | Rep #2 | Mean | Error |
| 0 | 0.0% | 0.0% | 0.0% | 0.0% | 0.0% |
| 4 | 35.0% | 14.8% | 23.0% | 18.9% | 4.1% |
| 7 | 51.7% | 41.1% | 34.8% | 37.9% | 3.2% |
| 11 | 71.1% | 55.2% | 53.1% | 54.2% | 1.0% |
| 14 | 77.6% | 62.9% | 59.7% | 61.3% | 1.6% |
| 21 | 85.7% | 71.9% | 70.2% | 71.1% | 0.9% |
| 28 | 89.5% | 73.2% | 77.2% | 75.2% | 2.0% |

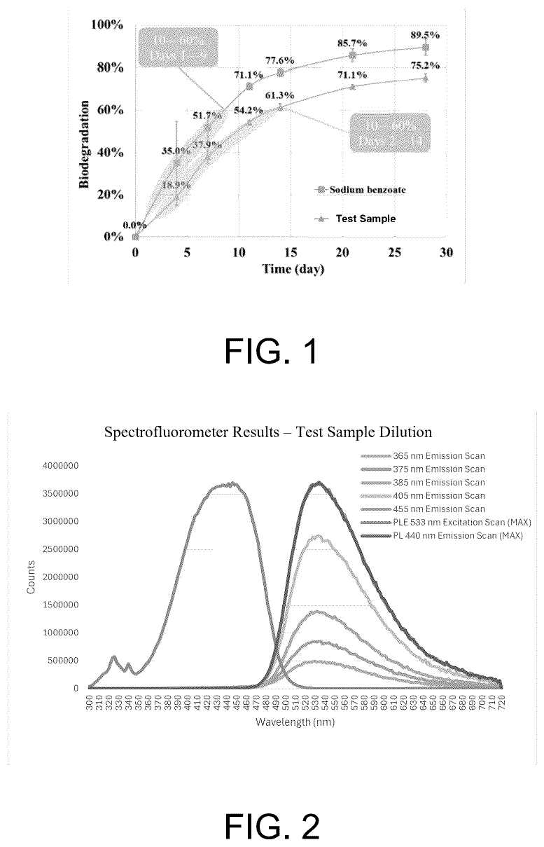

The degradation of the reference sample passed the 60% threshold within the 10-day window with a final value of 89.5% by day 28. The degradation of the test sample reached 10% by day 2, 60% by day 14, and 75.2% by day 28, indicating that the test sample passed the 60% threshold outside of the 10-day window requirement, FIG. 1. However, the OECD 301 test is intended for pure chemicals, and since the test sample is a composition comprising a fluorescent component and an oil base, wherein sequential degradation of the individual components is expected, the 10-day window was not applied to interpret the results of the test. As a result, the test sample may still be considered readily biodegradable without meeting the 10-day window criterion.

### Example 4: Leak Detection Studies

In this study, the performance in leak detection of the biodegradable dye composition of Example 1 was determined.

In particular, a sample containing 0.05% biodegradable dye composition in an ethanol dilution was prepared and the emission and absorption of the dye composition was measured using a spectrofluorometer and a UV-VIS spectrophotometer.

The biodegradable dye composition was found to have an emission maximum at 533 nm, FIG. 2.

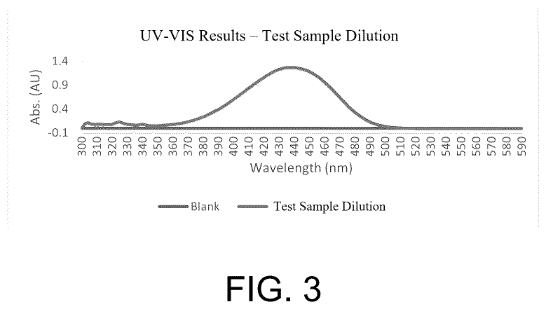

The biodegradable dye composition was found to have an absorption maximum at 438 nm, FIG. 3.

### ASPECTS

Aspect 1 is a biodegradable dye composition for detecting sites of fluid leakage, the composition comprising a fluorescent component and an oil base.
Aspect 2 is the biodegradable dye composition according to Aspect 1, wherein the biodegradable dye composition meets or exceeds the standards for readily biodegradable materials as defined by OECD 301B.
Aspect 3 is the biodegradable dye composition according to Aspect 1 or 2, wherein the fluorescent component comprises a fluorescing dye concentrate.
Aspect 4 is the biodegradable dye composition according to Aspect 3, wherein the fluorescing dye concentrate is a napthalimide dye, a perylene dye, a pyrene dye, an anthracene dye, or a coumarin dye.
Aspect 5 is the biodegradable dye composition according to Aspect 4, wherein the fluorescing dye concentrate is a napthalimide dye.
Aspect 6 is the biodegradable dye composition according to any one of Aspects 1 to 5, wherein the oil base is a biodegradable oil that is compatible with hydrocarbon-based systems.
Aspect 7 is the biodegradable dye composition according to Aspect 6, wherein the biodegradable oil is a polyol ester, a polyalkylene glycol, vegetable oil, a triglyceride ester, a synthetic ester, hydrotreated vegetable oil, a polyalphaolefin, canola oil, soybean oil, sunflower oil, castor oil, a pentaerythitol ester, a neopolyol ester, a diester, or a combination thereof.
Aspect 8 is the biodegradable dye composition according to Aspect 7, wherein the biodegradable oil is a polyol ester.
Aspect 9 is the biodegradable dye composition according to any one of Aspects 1 to 8, wherein the fluorescent component comprises about 2% to about 70% (v/v %) of the total composition.
Aspect 10 is the biodegradable dye composition according to any one of Aspects 1 to 8, wherein the fluorescent component comprises about 10% to about 50% (v/v %) of the total composition.
Aspect 11 is the biodegradable dye composition according to any one of Aspects 1 to 8, wherein the fluorescent component comprises about 15% to about 20% (v/v %) of the total composition.
Aspect 12 is the biodegradable dye composition according to any one of Aspects 1 to 11, wherein the biodegradable dye composition can detect leaks in machinery used in environmentally sensitive areas.
Aspect 13 is the biodegradable dye composition according to Aspect 12, wherein the environmentally sensitive areas include oceans, forests, mangrove forests, farmlands, wetlands, floodplains, coastal dunes, coral reefs, rivers, stream, marshes, estuaries, prairies, grasslands, deserts, critical wildlife habitats, wildlife sanctuaries, endangered species breeding grounds or nesting sites, freshwater springs, watersheds, aquifers, and national parks.
Aspect 14 is the biodegradable dye composition according to any one of Aspects 1 to 13, wherein the biodegradable dye composition is completely miscible in biodegradable hydraulic fluids, petroleum fuels, lubricating oils, and hydrocarbon solvents.
Aspect 15 is the biodegradable dye composition according to any one of Aspects 1 to 14, wherein the biodegradable dye composition is compatible with marine equipment and vessels, equipment for water treatment systems, agricultural equipment, forestry equipment, mining equipment, construction equipment, aerospace systems and equipment, automotive systems and equipment, energy and utility equipment, industrial hydraulic systems, industrial machinery, hydraulic excavators, drilling equipment, and generators.
Aspect 16 is the biodegradable dye composition according to Aspect 15, wherein the biodegradable dye composition is completely miscible in petroleum fuels, lubricating oils, and hydrocarbon solvents.
Aspect 17 is a method of detecting leaks in oil-based systems, comprising:
(a) introducing the biodegradable dye composition according to any one of Aspects 1 to 16 into the oil-based system, and
(b) detecting the leak.
Aspect 18 is the method according to Aspect 17, wherein the oil base is a biodegradable oil that is compatible with hydrocarbon-based systems.
Aspect 19 is the method according to Aspect 18, wherein the biodegradable oil is a polyol ester, a polyalkylene glycol, vegetable oil, a triglyceride ester, a synthetic ester, hydrotreated vegetable oil, a polyalphaolefin, canola oil, soybean oil, sunflower oil, castor oil, a pentaerythitol ester, a neopolyol ester, a diester, or a combination thereof.
Aspect 20 is the method according to Aspect 19, wherein the biodegradable oil is a polyol ester.
Aspect 21 is the method according to any one of Aspects 17 to 20, wherein the leak is detected with a lamp that emits light having a wavelength selected to cause the biodegradable dye composition to fluoresce.

1. A biodegradable dye composition for detecting sites of fluid leakage, the composition comprising a fluorescent component and an oil base.

2. The biodegradable dye composition according to claim 1, wherein the biodegradable dye composition meets or exceeds the standards for readily biodegradable materials as defined by OECD 301B.

3. The biodegradable dye composition according to claim 1, wherein the fluorescent component comprises a fluorescing dye concentrate.

4. The biodegradable dye composition according to claim 3, wherein the fluorescing dye concentrate is a napthalimide dye, a perylene dye, a pyrene dye, an anthracene dye, or a coumarin dye.

5. The biodegradable dye composition according to claim 4, wherein the fluorescing dye concentrate is a napthalimide dye.

6. The biodegradable dye composition according to claim 1, wherein the oil base is a biodegradable oil that is compatible with hydrocarbon-based systems.

7. The biodegradable dye composition according to claim 6, wherein the biodegradable oil is a polyol ester, a polyalkylene glycol, vegetable oil, a triglyceride ester, a synthetic ester, hydrotreated vegetable oil, a polyalphaolefin, canola oil, soybean oil, sunflower oil, castor oil, a pentaerythitol ester, a neopolyol ester, a diester, or a combination thereof.

8. The biodegradable dye composition according to claim 7, wherein the biodegradable oil is a polyol ester.

9. The biodegradable dye composition according to claim 1, wherein the fluorescent component comprises about 2% to about 70% (v/v %) of the total composition.

10. The biodegradable dye composition according to claim 1, wherein the fluorescent component comprises about 10% to about 50% (v/v %) of the total composition.

11. The biodegradable dye composition according to claim 1, wherein the fluorescent component comprises about 15% to about 20% (v/v %) of the total composition.

12. The biodegradable dye composition according to claim 1, wherein the biodegradable dye composition can detect leaks in machinery used in environmentally sensitive areas.

13. The biodegradable dye composition according to claim 12, wherein the environmentally sensitive areas include oceans, forests, mangrove forests, farmlands, wetlands, floodplains, coastal dunes, coral reefs, rivers, stream, marshes, estuaries, prairies, grasslands, deserts, critical wildlife habitats, wildlife sanctuaries, endangered species breeding grounds or nesting sites, freshwater springs, watersheds, aquifers, and national parks.

14. The biodegradable dye composition according to claim 1, wherein the biodegradable dye composition is completely miscible in biodegradable hydraulic fluids, petroleum fuels, lubricating oils, and hydrocarbon solvents.

15. The biodegradable dye composition according to claim 1, wherein the biodegradable dye composition is compatible with marine equipment and vessels, equipment for water treatment systems, agricultural equipment, forestry equipment, mining equipment, construction equipment, aerospace systems and equipment, automotive systems and equipment, energy and utility equipment, industrial hydraulic systems, industrial machinery, hydraulic excavators, drilling equipment, and generators.

16. The biodegradable dye composition according to claim 15, wherein the biodegradable dye composition is completely miscible in biodegradable hydraulic fluids, petroleum fuels, lubricating oils, and hydrocarbon solvents.

17. A method of detecting leaks in oil-based systems, comprising:
(a) introducing the biodegradable dye composition according to claim 1 into the oil-based system, and
(b) detecting the leak.

18. The method according to claim 17, wherein the oil base is a biodegradable oil that is compatible with hydrocarbon-based systems.

19. The method according to claim 18, wherein the biodegradable oil is a polyol ester, a polyalkylene glycol, vegetable oil, a triglyceride ester, a synthetic ester, hydrotreated vegetable oil, a polyalphaolefin, canola oil, soybean oil, sunflower oil, castor oil, a pentaerythitol ester, a neopolyol ester, a diester, or a combination thereof.

20. The method according to claim 19, wherein the biodegradable oil is a polyol ester.

21. The method according to claim 17, wherein the leak is detected with a lamp that emits light having a wavelength selected to cause the biodegradable dye composition to fluoresce.
